(19) United States
(12) Patent Application Publication
(10) Pub. No.: US 2007/0241955 A1
(43) Pub. Date: Oct. 18, 2007

(54) System Having Two or More Sensors

(75) Inventor: Thomas Brosche, Stuttgart (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 10/583,290

(22) PCT Filed: Nov. 8, 2004
(86) PCT No.: PCT/EP04/52848

§ 371 Date: Jun. 8, 2007

(30) Foreign Application Priority Data
Dec. 19, 2003 (DE) 103 60 889.3

(51) Int. Cl. G01S 13/08

(52) U.S. Cl. 342/128; 356/614; 367/99

(57) ABSTRACT

A system having two or more sensors is described. Each sensor has a transmitter and a receiver for signals, a sensor being able to receive a cross echo signal of another sensor. The sensors are also able to receive and evaluate the signals reflected by the other sensor without mutual interference, the sensors being decoupled from one another. In the receive mode, the sensors are temporally separated by the time delay of the transmission and reception signals.

### FIELD OF THE INVENTION

The present invention relates to a system having two or more communicating sensors, each sensor having a transmitter and at least one receiver for signals and one sensor being able to receive a cross echo signal of another sensor.

### BACKGROUND INFORMATION

Among other things, radar sensors are used in automotive engineering for monitoring the distance of a motor vehicle from a fixed or movable obstacle such as a pedestrian, e.g., when parking, and for displaying the distance from the obstacle to the driver of the motor vehicle via an appropriate means of display, including visual or acoustic means. Likewise, the distances from preceding and following highway users are monitored in high-speed travel, e.g., on an expressway or at low speed in bumper-to-bumper traffic. To this end, radar systems are installed at the front and/or at the rear and on the side to monitor the lateral area of the motor vehicle as a component of a radar system known to those skilled in the art. The radar system may also be a component of a driver assistance system, which is also known.

In a known manner, a radar system including pulse modulation has a pulse generator, a transmitter including a transmitting antenna, a receiver including a receiving antenna, and an electronic evaluation unit. The radar pulses emitted by the transmitting antenna are reflected on a target object and return to the receiver via the receiving antenna. There, they are mixed with a reference signal from the pulse generator, filtered by a low pass filter, and evaluated by an electronic evaluation unit after A/D conversion. It is thus possible to determine the distance to a target object as well as the speed of the target object in relation to the radar sensor and therefore to the motor vehicle. Instead of pulse modulation, other modulations, for example, FMCW, PSK, ASK, FSK, modulation using pseudo-noise (PN) codes, and additional methods or combinations of methods are possible.

If a plurality of radar sensors is provided on a motor vehicle, the radar signal emitted by one radar sensor can be reflected on the target and received by the antenna of another radar sensor as a cross echo. This can result in interference or superpositions with the self-echo of the radar signal emitted by this radar sensor. To make it possible to separate the signals of different sensors, it is known from German Patent No. 197 03 237, for example, to modulate the radar signal in the microwave range to be able in such a way to classify the signals of the self-echoes or cross echoes of different radars sensors based on their modulations.

Furthermore, Japanese Published Patent Application No. 07012928 and R. C. Dixon: “Spread Spectrum Systems,” 2nd edition, Wiley & Sons, New York, 1984, describe pseudo-noise (PN) codings for signal suppression and channel separation. The use of various codes for a plurality of radar sensors makes it possible to evaluate the cross echo signals of other radar sensors received by the receiver of one radar sensor. Mutually orthogonal codes for the radar signals may also be used for decoupling a plurality of radar sensors. European Published Patent Application No. 0 864 880 describes operating a plurality of radar sensors in alternation in order to decouple them in such a manner. Both the echo signals, i.e., the signals emitted by the transmitter associated with the particular radar sensor, as well as cross echo signals of other radar signals, are evaluated. German Patent No. 197 11 467 describes a comparable method for ultrasound sensors.

It must be seen as a disadvantage in this connection that considerable resources of switching and control technology are necessary for decoupling the various radar sensors from one another and for separating the received self-echo and cross echo signals from one another. The modulation of the radar pulses may also reduce the performance of a radar sensor. In alternating operation, e.g., according to European Published Patent Application No. 0 864 880, the radar sensors that are switched off on the transmitter side are unable to receive self-echo signals in the switched off state.

### SUMMARY OF THE INVENTION

The object of the present invention is to devise a system having two or more sensors, the sensors also being able to receive and evaluate the reflected signals of the particular other sensors without mutual interference and the sensors being decoupled from one another.

The core object of the present invention is that when a plurality of communicating sensors is used, the transmission and reception operation is tuned and timed to one another in such a way that each of the sensors of a system or of the particular assigned receiver receives or evaluates self-echo or cross echo signals only for specific intervals, the intervals of the time delay of the reception signal in relation to the associated transmission signal. In doing so, the different time intervals should not mutually overlap. This is achieved by selecting the phase angle of repetition frequency f_{w} of the transmission signal to be suitable for each sensor, i.e., different. The cited time intervals refer to twice the transit time of the signal moving at a speed, in particular at speed of light c.

It has surprisingly been found that the present invention may be used in different ways so that according to the present invention, the system may be a radar system having two or more communicating radar sensors, an optical system having two or more communicating optical sensors, or an ultrasound system having two or more corresponding ultrasound sensors.

According to a preferred embodiment, the system is a radar system having two or more communicating radar sensors, each radar sensor having a transmitter and at least one receiver for a modulated radar signal and a radar sensor being able to receive a cross echo signal of another radar sensor, according to the present invention, the radar sensors being separated from one another in reception operation by the time delay of the transmission and reception signals.

In this connection, in the system of the present invention, when a plurality of communicating radar sensors is used, the transmission and reception operation is tuned and timed to one another in such a way that each of the radar sensors of a radar system or of the particular assigned receiver receives or evaluates self-echo or cross echo signals only for specific intervals, the intervals of the time delay of the reception signal in relation to the associated transmission signal. In doing so, the different time intervals should not mutually overlap. This is achieved by selecting the phase angle of repetition frequency f_{w} of the transmission signal to be suitable for each radar sensor, i.e., different. The cited time intervals refer to twice the transit time of the signal moving at speed of light c.

This ensures that only one of the radar sensors ever receives the reflected radar signals of the associated transmitter in a specific interval for the delay. All communicating radar sensors transmit radar signals (e.g., pulses, PN code frames) continuously at repetition frequency f_{w} and are not switched off cyclically as provided, for example, in EP 0 864 880. A separation of the different received radar echoes, i.e., an analysis of the cross echo signals and the self-echoes, is then possible using the customary signal analysis methods or coding methods for the radar pulses.

The present invention is also applicable on radar systems that, for example, use carrier signals modulated using PN codes (e.g., using PKS, ASK or FSK modulation) instead of pulse modulation. In this case, it is possible to achieve a decoupling between the signals corresponding to the basic idea of the present invention independently of the code selected. In this connection, the communicating radar sensors simultaneously transmit repeating code frames at repetition frequency f_{w}, the code frames being suitably shifted or delayed in relation to one another. It is unnecessary to use different codes for the cited radar sensors.

The advantage of the present invention is that the signals of the various radar sensors are separated and decoupled. In addition, an evaluation of the cross echo signals transmitted by other radar sensors is possible. This makes it possible, for example, to determine the external shape of the target object that reflected the radar signals, e.g., a concave or convex shape or its size. A more precise trilateration or localization of the target objects is also possible and the occurrence of false targets due to incorrect assignments of single reflections may be significantly reduced.

In a pulse radar having a pulse repetition frequency f_{w}, the largest possible unambiguously measurable target distance without superposition of the received signal by a subsequent pulse is:
R_{eind}=c/(2f_{w}), where c=speed of light in the medium.

Repetition frequency f_{w}, for example, may also be the repetition frequency of a PN code frame of a PN radar.

Using the radar equation known, for example, from A. Ludloff: Praxiswissen Radar und Radarsignalverarbeitung (“Essentials of Radar and Radar Signal Processing”), 2^{nd} Edition, Vieweg, Wiesbaden, 1998, it is possible to set the maximum range Rₘₐₓ of each radar sensor in such a way that this target distance Rₘₐₓ, at which the radar signals reflected by targets are still registered in the receiver, corresponds maximally to distance R_{eind}, at which the received radar signals are still unambiguously assignable. This prevents a target from being measured at a distance that no longer allows an unambiguous measuring result.

Normally, the distance range monitored by a radar sensor starts at a minimum distance rₐ from the radar sensor if the immediate close range cannot be detected by the radar sensor. Thus an actual monitoring range [rₐ; r_{b}] of the radar sensor lies within the interval [0; Rₘₐₓ]. The particular signal transit times of the radar pulses from the transmitter to a target object in the detection range and back to the receiver are therefore in the time interval [2rₐ/c; 2r_{b}/c] and [tₐ; t_{b}], which in turn is in the possible time interval [0; 1/f_{w}] for unambiguous measurements. The time intervals for the i-nth of n radar sensors may differ from one another if different distance ranges are to be monitored.

If n cooperating and simultaneously active radar sensors are used and decoupled from one another in the radar system, the delays tₛᵢ of the periodic transmission signals of the individual radar sensors must be selected within the aforementioned interval [0; 1/f_{w}] in such a way that the delay times of the reception signals, each of which monitors a specific spatial distance, do not overlap in order to decouple them from one another. This is accomplished by selecting the delays tₛᵢ within a period of the repetition frequency f_{w} of the periodic transmission signals of the n radar sensors differently, e.g., according to the relation:
tₛᵢ=(i−1)*c/(2Rₘₐₓ) where i=1, 2, . . . , n
the particular i-nth radar sensor being able to receive its self-echoes or its cross echo signals from the particular other radar sensors within an interval:
[tₐᵢ; t_{bi}]=[tₛᵢ+tₐ; tₛᵢ+t_{b}].

In the case of PN coded radar signals in particular, it is possible to select a low repetition frequency f_{w} of the transmitted code frame. For example, for a 10 bit PN code and at a bit clock frequency or chip clock frequency of 250 MHz, this results in a repetition frequency of the code frame of f_{w}=244 kHz so that within the time interval of a code frame period of [0 s; 4 μs], an unambiguous distance measurement is possible using the radar sensor. This corresponds to a maximum possible unambiguous distance R_{eind} of 614 meters.

If, accordingly, the maximum range of all communicating radar sensors is set to Rₘₐₓ=200 m, it is possible in this example for up to three radar sensors to be operated decoupled from one another since the self-echoes are visible in the interval [0 m; Rₘₐₓ]; however, the cross echo signals of the particular other radar sensors appear at distances>Rₘₐₓ corresponding to the code delays of the transmission signals. The time synchronization of the code shift between the radar sensors may ensure that the particular delay intervals do not overlap. This does not require any excessively high precision.

However, in order to detect the cross echo signals of the other n−1 sensors (i=2 . . . n), it is necessary for the individual radar sensors or their transmitters to be precisely synchronized to one another and for the distance ranges detected by the sensors to lie in the correspondingly exactly shifted distance intervals:
[c/(2t_{s2 . . . n})+rₐ; c/(2t_{s2 . . . n})+r_{b}]

In this connection, a time delay of tₛᵢ of the transmission signal (radar pulse or PN coded carrier) of each individual radar sensor is determined in order to ensure that cross echo signals of the other communicating radar sensors are visible only for defined, disjunct intervals of time delay tₛᵢ and the accordingly corresponding apparent distance intervals in the receiver of the particular radar sensor. The self-echo signals of the corresponding sensor are evaluated as previously described.

The self-echo signal and the n−1 additional cross echo signals may be detected and evaluated sequentially or in a plurality of receiver units of a radar sensor. No additional receivers are necessary for the sequential detection. It is possible to combine both methods. The corresponding embodiments of the electronic evaluation units are possible for those skilled in the art.

It is understood that the decoupling of a plurality of radar sensors described above may also be used for acoustic sensors such as ultrasound sensors or for optical sensors, e.g., LIDAR sensors, for the most varied applications.

### BRIEF DESCRIPTION OF THE DRAWINGS

FIG. 1 shows a block diagram of a pulse radar.

FIG. 2 shows a detail of the exemplary division of the intervals for the time delay during the operation of a plurality of radar sensors.

FIG. 3 shows a block diagram of a pulse radar having a plurality of receivers.

### DETAILED DESCRIPTION

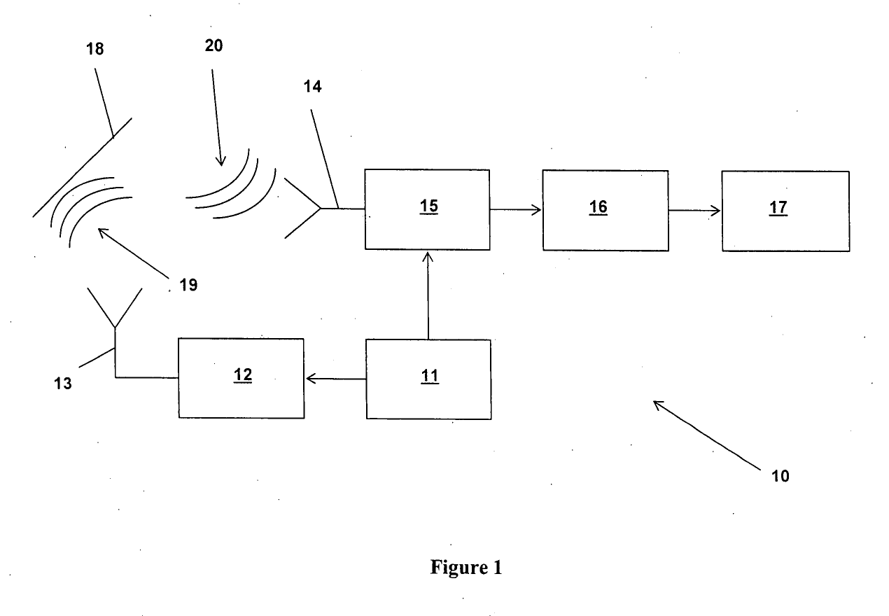

The schematic representation in FIG. 1 shows a radar sensor 10 of a pulse radar system known per se. Radar sensor 10 is primarily made up of a pulse generator 11, which causes a transmitter 12 to emit a radar pulse 19 via a transmitting antenna 13. Radar pulse 19 is reflected 20 on a target object 18, e.g., another motor vehicle, a fixed obstacle, or a pedestrian, and transferred by a receiving antenna 14 to a receiver 15 of radar sensor 10. Received signal 20 is mixed with a reference signal of pulse generator 11 and forwarded to an evaluation unit 17 via a low pass filter and an A/D converter 16. The reference signal may be temporally offset in relation to the transmission signal. In evaluation unit 17, received signal 20 is evaluated with respect to the distance and relative speed of target object 18 to radar sensor 10 or to a motor vehicle equipped with it.

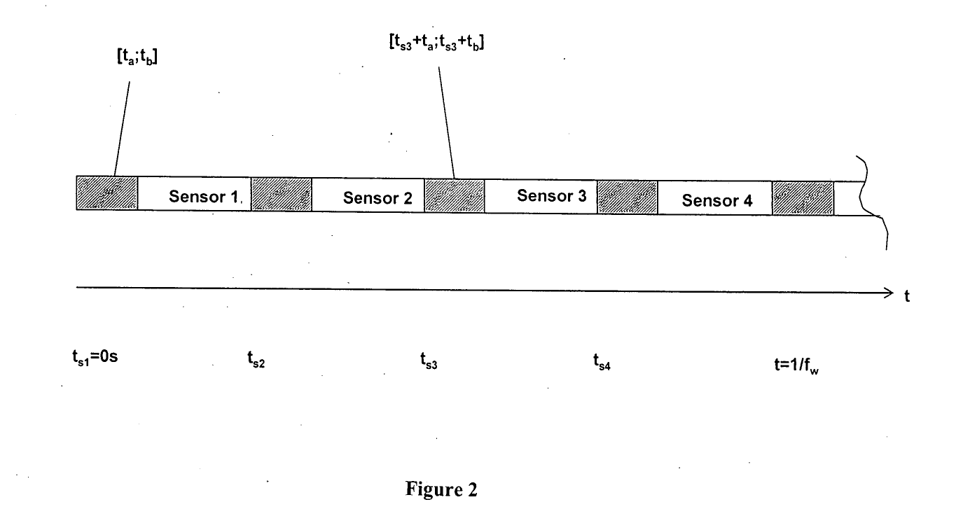

The depiction in FIG. 2 shows the separate operation of, for example, n=4 radar sensors 10 with respect to the delay times of the radar signals from one another, the arrow suggesting the variation over time starting at t=0 s. In a first interval [tₐ; t_{b}], the first of four radar sensors 10 receives its self-echo and each of the n−1 additional radar sensors receives the cross echo transmitted by the first radar sensor. In the interval [tₛ₃+tₐ; tₛ₃+t_{b}], first radar sensor 10 receives, for example, the cross echo signal of the 3^{rd} radar sensor, etc. The time periods between these reception intervals are necessary for ensuring unambiguity in the measurements of the self-echo and the cross echo with consideration of the radar equation. After the complete time period 1/f_{w}, a period is ended and the process is repeated. Continuously transmitting radar sensors 10 are thus decoupled or separated from one another in transmission and reception operation by the time delay in such a way that one radar sensor 10 is able to detect and process the self-echo signals and the cross echo signals of the other three radar sensors 10 without the occurrence of unintended interference or superpositions.

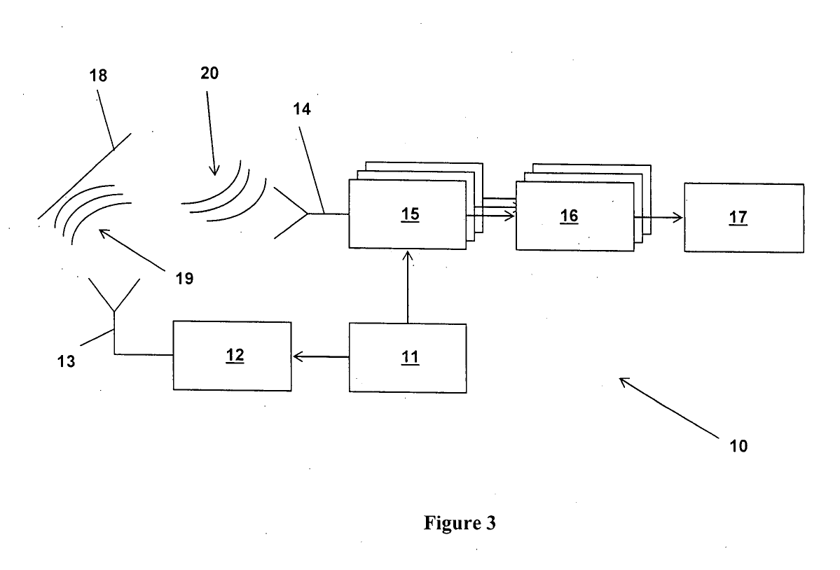

According to an exemplary embodiment of radar sensor 10 shown in FIG. 3, radar sensor 10 has three receivers 15 and accordingly three low pass filters and A/D converters 16 in order to receive and process one self-echo signal as well as two additional cross echo signals from two additional radar sensors 10, all of which are received by antenna 14, and forward them to a shared evaluation unit 17.

1-8. (canceled)

8. A system, comprising:
a plurality of sensors, each sensor including a transmitter and a receiver for signals, wherein:
one of the sensors being able to receive a cross echo signal of another of the sensors,
each of the sensors one of receives and analyzes one of self-echo signals and cross echo signals only for specific intervals relating to a time delay of a reception signal in relation to a transmission signal of its own, and
a phase angle of the repetition frequency f_{w} of the transmission signal is selected differently for each sensor.

9. The system as recited in claim 8, wherein the sensors include one of communicating radar sensors, communicating optical sensors, and communicating ultrasound sensors.

10. The radar system as recited in claim 9, wherein a carrier signal modulated by a PN code using one of ASK, PSK, BPSK, FSK, and a combination of at least two of ASK, PSK, BPSK, and FSK is used for the transmission signals of the radar sensors.

11. The radar system as recited in claim 10, wherein each of the radar sensors monitors a distance range (rₐ; r_{b}) to be monitored from the interval (0m; Rₘₐₓ) where: 0m≦rₐ≦r_{b}≦Rₘₐₓ.

12. The radar system as recited in claim 11, wherein n radar sensors transmit simultaneously, without interruption, an appropriately modulated transmission signal.

13. The radar system as recited in claim 9, wherein a first radar sensor receives the cross echoes of n−1 additional communicating radar sensors in the distance ranges (c/2t_{s2 . . . n})+rₐ;c/(2t_{s2 . . . n})+r_{b,} .

14. The radar system as recited in claim 9, wherein a self-echo signal and (n−1) cross echo signals are evaluated at least one of simultaneously and sequentially in a radar sensor when simultaneous evaluation of a plurality of receivers is provided.
